(19) United States
(12) Patent Application Publication
(10) Pub. No.: US 2007/0085250 A1
(43) Pub. Date: Apr. 19, 2007

(54) Shock absorbing member

(76) Inventor: Cheng-Chung Chang, Hsi-Chi City (TW)

Correspondence Address: LIN & ASSOCIATES INTELLECTUAL PROPERTY, P.O. BOX 2339, SARATOGA, CA, 95070-0339, US

(21) Appl. No.: 11/251,056

(22) Filed: Oct. 14, 2005

(51) Int. Cl. F16F 7/00

(52) U.S. Cl. 267/141.3

(57) ABSTRACT

A shock absorbing member includes a tubular body with two flanges extending radially outward from two ends of the tubular body. A passage is defined axially through the body. The body is engaged with a hole in one object and the two flanges are in contact with the top surface and the bottom surface of the object. A bolt extends through the passage of the shock absorbing member and is threadedly connected to another object.

### BACKGROUND OF THE INVENTION

1. Field of the Invention

The present invention relates generally to a shock absorbing member which is cooperated with a bolt to position two objects and able to absorb shocks.

2. The Prior Arts

A conventional way to connect two objects is to use bolts which extend through the two objects and is connected with a nut. If one of the object may vibrate, in order to avoid noise generated from the vibration, a washer is used to absorb the vibration. The washer can be made by soft material so as to absorb vibration by limited deformation. However, the washer can only provide limited function to keep the bolt from being loosened by the vibration. Although the thickness of the washer can be increased, the total height that protrudes from the object will be too high and might tangle foreign objects. Multiple bolts can also be used to enhance the connection, this increases time required in assembling and multiple holes have to be drilled in the objects.

FIG. 1 shows a circuit board 3 is connected to an object 5 by using a bolt 1 which extends through an upper washer 2, the circuit board 3, a lower washer 4 and the object 5. If the circuit board 3 is affected by a fan 7 and vibrates by the vibration from the fan 7, the vibration is transferred to the object 5 via the thread 6 of the bolt 1 which is in contact with the two washers 2, 4, the circuit board 3 and the object 5. The vibration can loosen the bolt 1.

### SUMMARY OF THE INVENTION

A primary objective of the present invention is to provide a shock absorbing member which is made by soft material to avoid the vibration transferred to the object and the bolt so as to reduce noise and vibration.

A second objective of the present invention is to provide a shock absorbing member which keeps the bolt from the vibration so that the bolt is not loosened by the vibration.

A third objective of the present invention is to provide a shock absorbing member which can be manufactured easily and without complicated machine needed.

The present invention includes a shock absorbing member that includes a body with two flanges extending radially outward from two ends of the body and a passage is defined axially through the body. The body of the shock absorbing member is located between the bolt and the hole that receives the body of the shock absorbing member such that the vibration can be effectively isolated from the bolt.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a cross-sectional view to show a conventional way of connection of the computer case and the object;

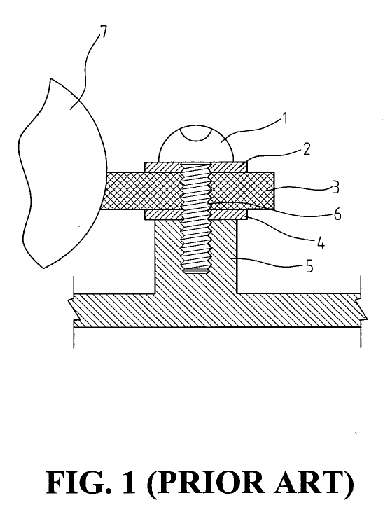

FIG. 2 is perspective view of the shock absorbing member of the present invention;

FIG. 3 is a cross-sectional view to show that a shock absorbing member is used to connect the computer case and the object by a bolt;

FIG. 4 is another embodiment of the shock absorbing member;

FIG. 5 is yet another embodiment of the shock absorbing member, and

FIG. 6 shows a circuit board is fixed to the computer case by the shock absorbing members and bolts.

### DETAILED DESCRIPTION OF THE PREFERRED EMBODIMENT

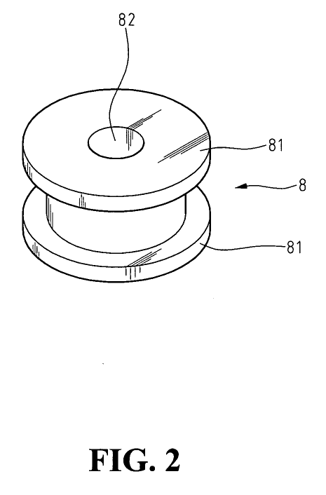

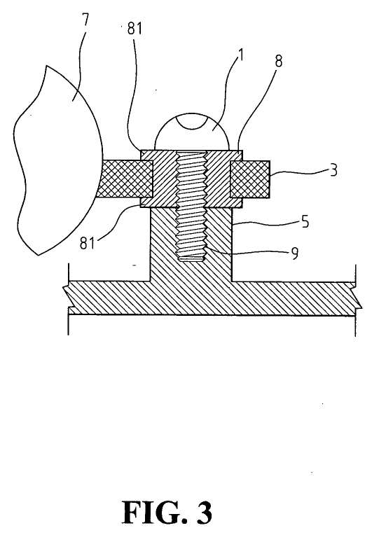

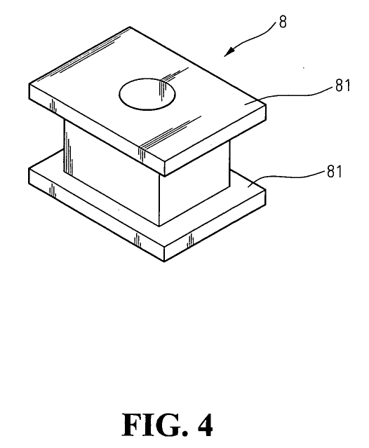

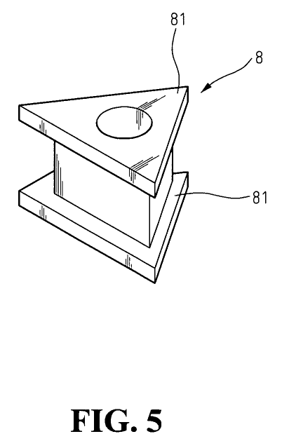

With reference to the drawings and in particular to FIGS. 2 and 3, the shock absorbing member of the present invention is made by soft material such as rubber and comprises a body with two flanges 81 extending radially outward from two ends of the body, and a passage 82 is defined axially through the body. Each of the two flanges 81 can be a circular flange as shown in FIG. 2, a rectangular flange as shown in FIG. 4 or a triangular circular flange as shown in FIG. 5. The body of the shock absorbing member 8 can be a cylindrical body as shown in FIG. 2, a polygonal body such as a rectangular body as shown in FIG. 4 or a triangular body as shown in FIG. 5.

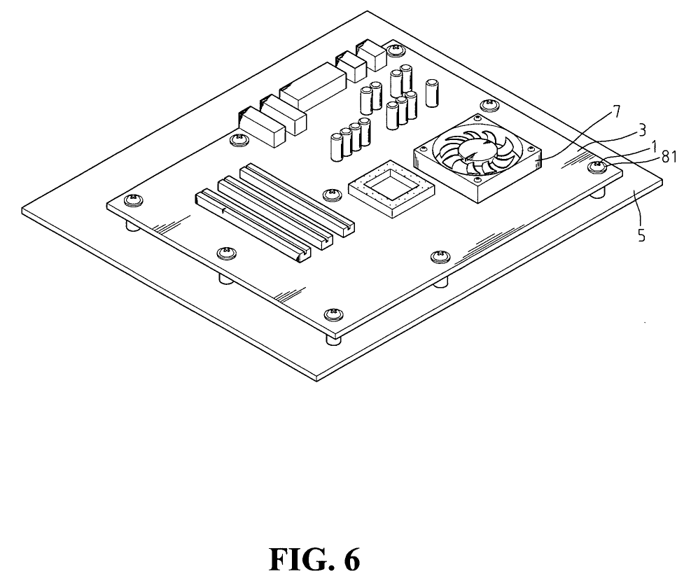

Referring to FIGS. 3 and 6, when connecting a circuit board 3 to a object 5 such as a fixing board 5, the circuit board 3 includes a plurality of holes and each hole has a shock absorbing member 3 received therein. The body of the shock absorbing member 8 is engaged with the hole in the circuit board 3 and the two flanges 81 are respectively in contact with the top surface and the bottom surface of the circuit board 3. A bolt 1 extends through the passage 82 of the shock absorbing member 8 and is threadedly connected to a threaded hole 9 in the object 5. When the vibration from the fan 7 is transferred to the circuit board 3, the body effectively isolates the vibration from the bolt 1 and the two flanges 81 enhance the connection of the circuit board 3 and the object 5 by the bolt 1.

The vibration from the circuit board 3 is stopped by the shock absorbing member 8 in which the bolt 1 extends so that the bolt 1 is not affected by the vibration. The two flanges 81 of the shock absorbing member 8 clamps the circuit board 3 so that the vibration is absorbed by the shock absorbing member 8 and the flanges 81 also enhances the connection of the connection of the bolt 1, the shock absorbing member 8 and the circuit board 3.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A shock absorbing member comprising:
a body with two flanges extending radially outward from two ends of the body, a passage defined axially through the body.

2. The shock absorbing member as claimed in claim 1, wherein each of the two flanges is a circular flange.

3. The shock absorbing member as claimed in claim 1, wherein each of the two flanges is a triangular circular flange.

4. The shock absorbing member as claimed in claim 1, wherein each of the two flanges is a rectangular flange.

4. The shock absorbing member as claimed in claim 1, wherein each of the two flanges is a triangular circular flange.

5. The shock absorbing member as claimed in claim 1, wherein the body is a cylindrical body.

6. The shock absorbing member as claimed in claim 1, wherein the body is a polygonal body.

7. The shock absorbing member as claimed in claim 1, wherein the body and the two flanges are made by rubber.
